(19) United States
(12) Patent Application Publication
(10) Pub. No.: US 2008/0294691 A1
(43) Pub. Date: Nov. 27, 2008

(54) METHODS FOR GENERATING AND PLAYING MULTIMEDIA FILE AND RECORDING MEDIUM STORING MULTIMEDIA FILE

(75) Inventors: Li-Ying Chang, Changhua County (TW); Chia-Wei Pan, Hsinchu City (TW); Yu-Chih Chen, Hsinchu City (TW)

Correspondence Address: J C PATENTS, INC., 4 VENTURE, SUITE 250, IRVINE, CA, 92618, US

(73) Assignee: SUNPLUS TECHNOLOGY CO., LTD., Hsinchu (TW)

(21) Appl. No.: 11/839,322

(22) Filed: Aug. 15, 2007

(30) Foreign Application Priority Data
May 22, 2007 (TW) 96118196

(51) Int. Cl. G06F 17/30

(52) U.S. Cl. 707/104.1

(57) ABSTRACT

Methods for generating and playing a multimedia file and a recording medium storing the multimedia file are provided. In the generating method, multimedia data to be written in the multimedia file is generated, and then a media chunk for storing the multimedia data is generated. Next, a metadata chunk including metadata that describes the characteristics of the media chunk and the multimedia data is generated by analyzing the characteristics of the media chunk. Afterwards, the metadata chunk and the media chunk are written into the multimedia data file. When all the media chunks have been written, the multimedia file is scanned and the metadata chunks therein are read, such that an index table recording the relations among the multimedia data is generated in the multimedia file. Therefore, the procedure for generating the multimedia file is simplified and the time for preparing the play of the multimedia file is reduced.

### CROSS-REFERENCE TO RELATED APPLICATION

This application claims the priority benefit of Taiwan application serial no. 96118196, filed on May 22, 2007. All disclosure of the Taiwan application is incorporated herein by reference.

### BACKGROUND OF THE INVENTION

1. Field of the Invention

The present invention relates to methods for generating and playing a multimedia file, and more particularly, to methods for generating and playing a multimedia file that includes a metadata chunk added in front of each media chunk.

2. Description of Related Art

Multimedia files usually include a header (e.g. media information), multimedia data (e.g. video data, audio data, sub-picture data or the like), and relations among the multimedia data. The arrangement of these data varies with different formats of the multimedia files. FIG. 1 is a schematic view illustrating the arrangement of the data of the multimedia file. Referring to FIG. 1(a), arranged in the front is a header, which records information that describes characteristics of the multimedia data, such as size and length of the multimedia data; arranged in the middle is a multimedia data section, for storing the multimedia data itself, which may be video data, audio data, or sub-picture data, or the like; arranged in the back is an index table section, which records the arrangement of the multimedia data. Audio Video Interleave (AVI) format multimedia files record data in this order.

Referring to FIG. 1(b), data is recorded in the order of header, index table, and multimedia data section. However, referring to FIG. 1(c), data is recorded in the order of multimedia data section, header, and index table. According to these two arrangements, the whole multimedia data section is placed in the front or back of the multimedia file, while the information recording the characteristics of the multimedia data and the information recording the order of the multimedia data are placed together, and sometimes are even combined. Common multimedia files that record data in these arrangements are of a format of International Organization for Standardization Moving Pictures Experts Group 4 (ISO-MP4).

However, in the foregoing three data arrangements, different types of multimedia data (such as video data, audio data and sub-picture data) in the multimedia data section are stored in an interleaving fashion. FIG. 2 illustrates an example of one arrangement of the multimedia data, in which the multimedia data includes a plurality of chunks stored in the multimedia data section in an alternating fashion, and each chunk includes a plurality of data samples. As shown in FIG. 2, in this example, the chunks of video data, audio data, and sub-picture data are arranged repeatedly but unnecessarily in a particular order, such that a multimedia player can sequentially read and play various multimedia data.

However, when a multimedia file with the chunks arranged in the foregoing fashion is generated, it is often needed to create a plurality of temporary storage files or use memories to store the relations among these alternately stored multimedia data. Each of the two methods has its own disadvantages as described hereinafter.

When a rewritable storage media is used, a plurality of temporary storage files can be used to store multimedia-related information, multimedia data, and the relations among the multimedia data. FIG. 3 illustrates a flow chart of a conventional method for generating a multimedia file. Referring to FIG. 3, in this method, multimedia-related information (excluding relations among the data) is first written into file 1 (S310). Next, the type (e.g. video data, audio data, and sub-picture data, or the like) of the multimedia data is determined, and the different types of multimedia data are stored in file 2 in an interleaving fashion (S320), and simultaneously, the relations among the different types of multimedia data are written into file 3 (S330), and it is determined whether there is any multimedia data not processed (S340). If there is any multimedia data not processed, the process flow returns to step S320 to continue writing the rest of multimedia data and relations thereof; when all the multimedia data is processed, the file 1, file 2, and file 3 are written into file 4 in a desired order (as shown in FIG. 1) (S350), and then the file 1, file 2, and file 3 are deleted (S360) to generate the desired multimedia file 4. In this conventional method, the generation of the multimedia file becomes complex and increases the time needed for generating the multimedia file.

On the other hand, the method of using memory is to record data in the memory. FIG. 4 illustrates a flow chart of another conventional method for generating a multimedia file. Referring to FIG. 4, in this method, multimedia-related information (excluding relations among the data) is likewise first written into file 1 (S410). Next, according to a storage order required by the multimedia file format, a space for storing relation data among the multimedia data is preserved in back of the multimedia-related information (S420). Next, the type (e.g. video data, audio data, and sub-picture data, or the like) of the multimedia data is determined, and the multimedia data is stored in file 1 in an interleaving fashion (S430), and simultaneously, the relation data among the multimedia data are temporarily store determined whether there is any multimedia data not processed (S450). If there is any multimedia data not d into the memory (S440), and it is then processed, the process flow returns to step S430 to continue writing multimedia data and relation data thereof; after all the multimedia data is processed, the relation data among the multimedia data is written into the preserved space according to the preserved space and the size of the relation data among the multimedia data (S470), and the relation data among the multimedia data temporarily stored in the memory is deleted (S470). However, in this method, substituting the plurality of temporary storage files with the memory increases the demand for the memory. In addition, the size of the relation data varies with different multimedia data, for example, multimedia data play time, multimedia data compression method, or the like. As a result, pre-estimate of the preserved space can be difficult, making it more difficult to generate the multimedia file.

### SUMMARY OF THE INVENTION

The present invention relates to a method for generating a multimedia file which can simplify the procedure of generating the multimedia file by adding a data chunk in front of each of a plurality of media chunks to record the characteristics of the multimedia data stored in the plurality of media chunks.

The present invention relates to a method for playing a multimedia file in a skip or sequential manner by directly reading the data chunk in front of each media chunk, thereby reducing the time for reading the multimedia file information back and forth and increasing the speed for playing the multimedia file.

The present invention relates to a multimedia player readable recording medium for recording multimedia files that include a plurality of media chunks, and a data chunk added in front of each media chunk to record the information about each media chunk, thereby facilitating reading and playing of the multimedia file by a multimedia player. The recording medium may include a hard disk, a floppy disk, an optical disk (e.g. CD, DVD, CD-ROM, CD-RW, DVD-RW, or the like), a portable hard disk, a flash memory, and the multimedia player may include a computer, a CD player, a DVD player, or the like.

A method for generating a multimedia file is provided. In this method, multimedia data to be written in the multimedia file is generated, and then a media chunk for storing the multimedia data is generated. Next, a metadata chunk including metadata that describes the characteristics of the media chunk and the multimedia data is generated by analyzing the characteristics of the media chunk. Afterwards, the metadata chunk and the media chunk are written into the multimedia file, with the metadata chunk being arranged in front of the media chunk. Finally, it is determined whether there are other media chunks to be written into the multimedia file, and the above steps are repeated to generate other metadata chunks and other media chunks if there are other media chunks to be written into the multimedia file.

In one embodiment of the present invention, the method further comprises a step of opening and initializing the multimedia file before generating the multimedia data to be written into the multimedia file. The step of initializing includes generating a header and data tracks, wherein the data track including a metadata track, an audio data track, a video data track, and a sub-picture data track.

In one embodiment of the present invention, the method comprises scanning the multimedia file and reading the metadata chunks to generate an index table in the multimedia file, wherein the index table records relations among the multimedia data after all the media chunks have been written into the multimedia file. According to the format of the multimedia file, the index table may further include a time to sample table, a sample to chunk table, a sample size table, a sync sample table, and a chunk offset table of the multimedia data.

In one embodiment of the present invention, the method comprises scanning the multimedia file to read the metadata chunk and generating an index table that records relations among the multimedia data once one group of metadata chunk and media chunk are written into the multimedia file, and writing the index table into the multimedia file after all the media chunks are written into the multimedia file.

In one embodiment of the present invention, the step of generating the multimedia data comprises one of encoding, transcoding, and re-multiplexing or any combination thereof.

In one embodiment of the present invention, the type of the multimedia data includes video data, audio data, and sub-picture data, which are stored in the multimedia file in an alternating fashion.

In one embodiment of the present invention, the metadata includes: one of video track number, video frame number, video frame type, and time, size and length of each video frame of the video data or any combination thereof; one of audio track number, audio frame number, audio frame type, and time, size and length of each audio frame of the audio data or any combination thereof; and one of sub-picture track number, sub-picture number, and time, size and length of each sub-picture of the sub-picture data or any combination thereof.

In one embodiment of the present invention, the format of the multimedia file comprises one of Audio Video Interleave (AVI) format, and International Organization for Standardization Moving Pictures Experts Group (ISO-MP4) format.

A method for playing a multimedia file including metadata chunk is provided. The multimedia file includes a plurality of media chunks for recording a plurality of pieces of multimedia data, and a metadata chunk arranged in front of each media chunk. The metadata chunk includes metadata that describes the characteristics of the multimedia data. The method comprises opening and initializing the multimedia file. Next, the metadata chunk is parsed to acquire the characteristics of the media chunk. Next, the multimedia data is de-multiplexed using the characteristics acquired by parsing the metadata chunk; and finally the multimedia data is decoded and played.

In one embodiment of the present invention, the method further comprises parsing the multimedia file, and generating a random access table via computation. After the step of generating the random access table, according to a time to be played, a position of the time is searched to play in the multimedia file in the random access table, and the demultiplexing of the multimedia file from the position is started, and multimedia data corresponding to the time is decoded and played.

In one embodiment of the present invention, the method further comprises after the step of decoding and playing the multimedia data, determining whether there is any multimedia data not decoded; if there is any multimedia data not decoded, continuing the step of parsing; demultiplexing the multimedia file, and decoding and playing the remaining multimedia data.

A multimedia player readable recording medium is provided. The recording medium is configured to record therein a multimedia file including a header and a multimedia data section. The header includes a description of the characteristics of a data track. The multimedia data section is configured to store data of the data track, and includes a plurality of media chunks and a plurality of metadata chunks. The media chunks are arranged in the multimedia data section and configured to store multimedia data, respectively. The metadata chunks are arranged in the multimedia data section in front of the media chunks, and configured to store metadata that describes the characteristics of the media chunks and the multimedia data, respectively.

During generation of the multimedia file, a metadata chunk is added in front of each media chunk, and the characteristics of multimedia data stored in a plurality of media chunks are recorded in the metadata chunk, thereby simplifying the procedure of generating the multimedia file. The multimedia file generated using this method also allows the multimedia data stored therein to be rapidly read and played by a multimedia player.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating the arrangements of the data of the multimedia file.

FIG. 2 illustrates an example of the arrangement of multimedia data.

FIG. 3 illustrates a flow chart of a conventional method for generating a multimedia file.

FIG. 4 illustrates a flow chart of a conventional method for generating a multimedia file.

FIG. 5 is a schematic view illustrating a multimedia file structure according to a first embodiment of the present invention.

FIG. 6 is a flow chart of a method for generating a multimedia file according to a second embodiment of the present invention.

FIG. 7 is a flow chart of a method for sequentially playing a multimedia file.

FIG. 8 is a flow chart of a method for skip playing a multimedia file according to a fourth embodiment of the present invention according to a fifth embodiment of the present invention.

FIG. 9 is a flow chart of a method for generating a multimedia file according to a fifth embodiment of the present invention.

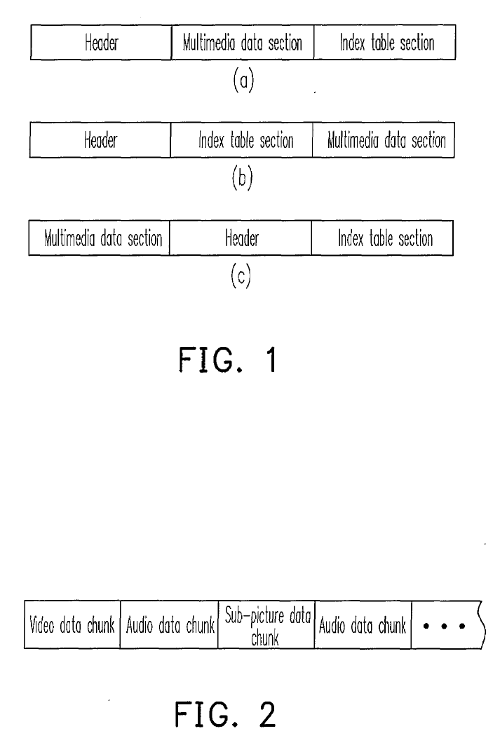

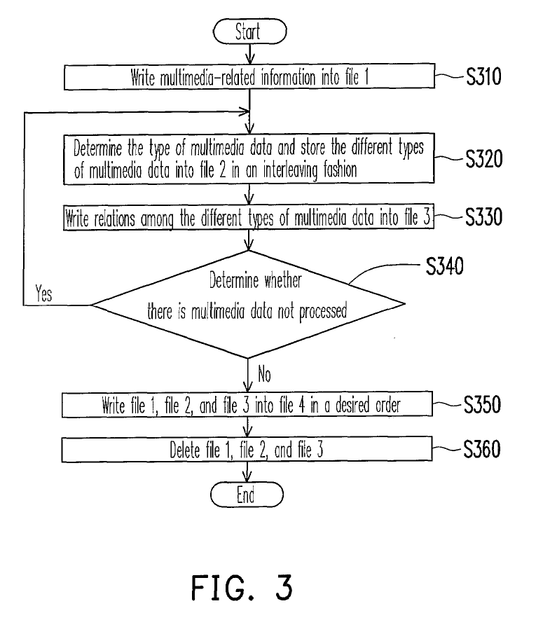

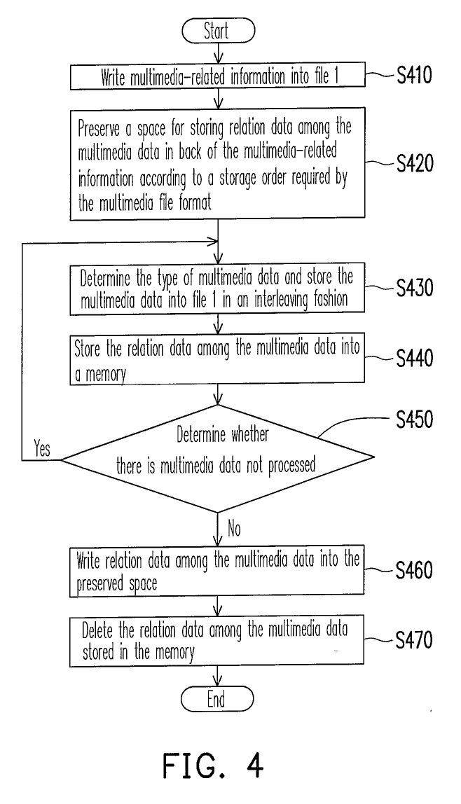

### DESCRIPTION OF THE EMBODIMENTS

It can be understood, by analyzing the two conventional methods for generating a multimedia file, that complex steps need to be carried out and the memory needs to be increased to calculate the relations among the multimedia data because the plurality of pieces of multimedia data are stored alternately and the multimedia data along with relations among the multimedia data are stored in one file. Therefore, the procedure of generating the multimedia file can be simplified by reducing the simultaneous storage and calculation steps. Accordingly, the present invention provides methods for generating and playing a multimedia file developed according to the foregoing concept. For a better understanding of the present invention, reference will now be made in detail to the present preferred embodiments of the invention, examples of which are illustrated in the accompanying drawings.

### First Embodiment

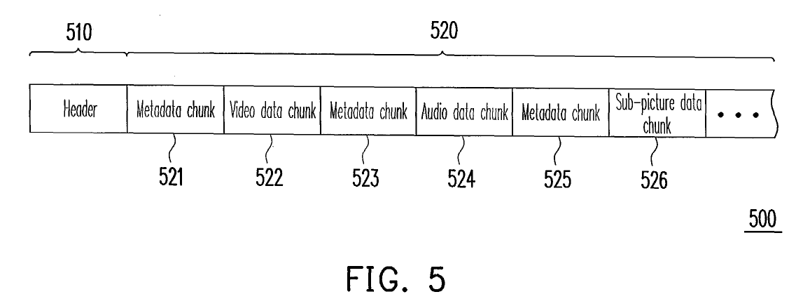

A main principle of the present invention is to add a metadata chunk into a multimedia file in front of a media data chunk (e.g. video data chunk, audio data chunk, and sub-picture data chunk, or the like), for describing the characteristics of multimedia data (e.g. video data, audio data, and sub-picture data, or the like) stored in the media data chunk, and for assisting in establishing data needed by the multimedia file. FIG. 5 is a schematic view illustrating a multimedia file architecture in accordance with a first embodiment of the present invention. Referring to FIG. 5, the multimedia file 500 of this embodiment may include a header 510 and a multimedia data section 520. In one example, if the multimedia file is of an AVI format, the multimedia file further includes an index table section. The header 510 includes the description of characteristics of the data tracks including a video track, a audio track, a sub-picture track, and a metadata track. One multimedia file usually has one or more data tracks used to sort the multimedia data, and record existence and type of the data and related information. The video track (usually there is only one) is used to sort the video data; the audio track is used to sort the audio data, and different audio tracks may represent different languages; the sub-picture track is used to sort the sub-picture data, and the different sub-picture tracks may represent sub-pictures of different languages.

Notably, the present invention further includes adding a metadata track in the header 510. This metadata track is used to sort out the metadata from other data, and records the format and type of the metadata, and related information thereof. When the multimedia file is played, the header is first scanned, and the type of multimedia data and metadata included in the multimedia file is determined by means of different data tracks (audio, video, sub-picture and metadata tracks).

The multimedia data section 520 is used to store the data of the data tracks including a plurality of media chunks and metadata chunks. In one example, as shown in FIG. 5, the media chunks are arranged in the order of video data chunk 522, audio data chunk 524, and sub-picture data chunk 526, which store video data, audio data, and sub-picture data, respectively. In another example, the media data chunks are not arranged in a particular order and may be arranged in any combination. Metadata chunks 521, 523, 525 are arranged in front of these media chunks, respectively, to record metadata that describes the characteristics of the multimedia data, these data being described in detail as follows.

The metadata chunk 521 in front of the video data chunk 522 records data including, for example, video track number, video frame number, video frame type, and time, size, and length of each video frame of the video data, or the like. The metadata chunk 523 in front of the audio data chunk 524 records data including, for example, audio track number, audio frame number, and time, size, and length of each audio frame of the audio data, or the like. Besides, the metadata chunk 525 in front of the sub-picture data chunk 526 records data including, for example, sub-picture track number, sub-picture number, and time, size, and length of each sub-picture of the sub-picture data, or the like.

After being alternately arranged with all the multimedia data, these metadata can be used to provide information (e.g. relations among the multimedia data) necessary to re-establish the multimedia file. These metadata chunks are permanently stored in this multimedia file. Because the metadata stored in the metadata chunks are merely used to describe the characteristics of corresponding media chunks, data amount added by the metadata will not cause substantial effect to the size of the multimedia file. These newly added metadata chunks may possibly be incompatible with some multimedia players. In that case, these incompatible multimedia players will ignore these metadata and can still read the multimedia data using conventional methods (e.g. referring to an index table), without affecting the normal function of the multimedia players.

### Second Embodiment

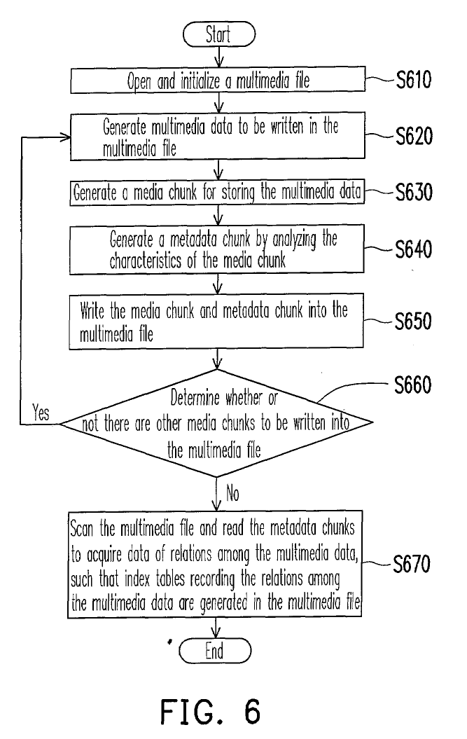

In connection with the new architecture of the multimedia file, the present invention correspondingly provides a method for generating the multimedia file. FIG. 6 is a flow chart of a method for generating a multimedia file according to the second embodiment of the present invention. Referring to FIG. 6, the multimedia file format according to the embodiment includes, but not limited to, AVI format and ISO-MP4 format.

In this embodiment, a multimedia file is first opened and initialized (S610). The step of initializing the multimedia file includes generating a header and tracks. In the step of generating the header, besides a video track, an audio track, and a sub-picture track, the present invention further comprises generating a metadata track for sorting out metadata from other data. The metadata track records the format and type of the metadata, and related information thereof, and what type of metadata is included in the multimedia file can be determined via the metadata track. Description of this metadata has been made with respect to the first embodiment, and is therefore not repeated herein.

The next step is to generate multimedia data to be written in the multimedia file (S620). The multimedia data is generated using one of encoding, transcoding, and re-multiplexing (Re-MUX), or any combination thereof.

Next, a media chunk for storing the multimedia data is generated (S630). Next, a metadata chunk including metadata that describes characteristics of the media chunk and the multimedia data is generated by analyzing the characteristics of the media chunk, for example, length, format, and size of the media chunk (S640). Herein, the media chunk and the metadata chunk are first generated in a memory and are then written into the multimedia file (S650), with the metadata chunk being arranged in front of the media chunk.

Notably, the type of the multimedia data includes, but not limited to, video data, audio data, and sub-picture data, or the like. Metadata chunks that are generated by different types of multimedia data record the different characteristics of multimedia data. The metadata corresponding to the video data records data including, for example, video track number, video frame number, video frame type, and time, size, and length of each video frame of the video data, or the like. The metadata corresponding to the audio data records data including, for example, audio track number, audio frame number, and time, size, and length of each audio frame of the audio data, or the like. The metadata corresponding to the sub-picture data records data including, for example, sub-picture track number, sub-picture number, and time, size, and length of each sub-picture of the sub-picture data, or the like.

In step S650, once a group of media chunk and metadata chunk are written into the multimedia file, the recording of a group of multimedia data is completed. However, in practice, the generation of a multimedia file usually includes recording a plurality of pieces of multimedia data which are usually stored in the multimedia file in an alternating fashion of video data, audio data, and sub-picture data. Therefore, after the recording of each group of media chunk and metadata chunk is completed, it is further determined whether or not there are other media chunks to be written into the multimedia file (S660). If it is determined that there are other media chunks to be written, then the process flow returns to the step S620 and repeats the steps S620 through S650 to generate other metadata chunks and other media chunks in the multimedia file.

Finally, when all the media chunks have been written into the multimedia file, data recording relations among the multimedia data is generated in the multimedia file, so as to make the multimedia file compatible with various multimedia players. To generate this data, the multimedia file is scanned and the metadata chunks therein are read to acquire data of relations among the multimedia data, such that the index tables recording the relations among the multimedia data are generated in the multimedia file (S670).

In one example, if the multimedia file is of ISO-MP4 format, for example, then five index tables are correspondingly generated in each track of multimedia data of the multimedia file, including time to sample table, sample to chunk table, sample size table, sync sample table, and chunk offset table. Therefore, if the multimedia file includes n tracks of multimedia data, 5n index tables will be generated in the header.

In another example, if the multimedia file is of AVI format, then only one index table will be generated in back of the multimedia data section, for recording relations among multiple pieces of multimedia data of the multimedia file.

Notably, in one embodiment, the index table is generated by scanning metadata chunks of the multimedia file after all the media chunks have been written into the multimedia file. However, in another embodiment, the index table may also be first generated by scanning metadata chunk of the multimedia file once one group of metadata chunk and media chunk are written into the multimedia file, and be temporarily stored in a memory. After all the media chunks are written into the multimedia file, the index table stored in the memory is updated and then written into the multimedia file.

After the index table is added into the multimedia file, the whole procedure for generating the multimedia file is completed. The multimedia file can then be recorded on a recording medium, for example, an optical disk or a hard disk, which is readable by a multimedia player, allowing the multimedia player to read and play. The present invention also provides a method for playing this multimedia file, such that the multimedia player can utilize the newly added metadata chunk and metadata in the multimedia file of the present invention to increase the speed of opening and reading the multimedia file.

During the playback of the multimedia file, two playing methods are usually used. One method is so called sequential play, which means reading and playing the multimedia file from the beginning thereof track by track. The other method is skip play, which means starting the playback of the multimedia data in a multimedia file from at arbitrary section of the multimedia file. An example of each playing method is given as follows.

### Third Embodiment

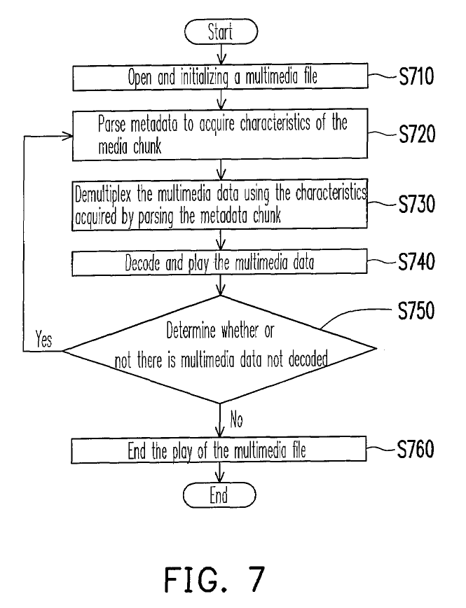

FIG. 7 is a flow chart of a method for sequentially playing a multimedia file. Referring to FIG. 7, the method of this embodiment is adapted to sequentially play the multimedia file as described in the first embodiment. That is, the multimedia file includes multiple media chunks for recording multiple pieces of the multimedia data, a metadata chunk is included in front of each media chunks, and the metadata chunk records metadata that is used to describe the characteristics of the multimedia data.

First of all, the multimedia file is opened and initialized (S710). Detail steps of initializing the multimedia file are identical or similar to those described in the previous embodiment, and are not repeated herein.

Next, metadata in the multimedia file is parsed to acquire the characteristics of the media chunk (S720). The metadata is disposed in front of each of the media chunks to record the characteristics of the media chunks, including time, size, and length, or the like. When sequentially playing the multimedia file, the multimedia player also first reads the metadata chunks to acquire the characteristics of a next media chunk to be played in advance.

Here, the characteristics acquired by parsing the metadata chunks can be directly used to demultiplex (demux) the multimedia data (S730), and decode and play the multimedia data (S740). Notably, in one example, the multimedia file can be parsed after the step of initializing the multimedia file, and through computation, a random access table is generated. In another example, when the multimedia file is stored, for example, on a hard disk of a computer, the step of generating the random access table can be omitted because the speed of accessing the hard disk is sufficiently fast and the memory of the computer is sufficient. These are believed to be within the knowledge of those of ordinary skill in the art and therefore are not described herein in detail.

Finally, it is determined whether or not there is any multimedia data not decoded (750). If there is any multimedia data not decoded, the process flow returns to step S720 to continue parsing the metadata chunks to demux the multimedia file, and decode and play the remaining multimedia data until all the multimedia data is decoded. Next, the play of the multimedia file is ended (760).

In summary, in sequentially playing a multimedia file, since the metadata chunks of the multimedia file of the present invention has already recorded the characteristics of each piece of multimedia data, all information about the next media chunk and metadata to be read can be acquired by reading the previous metadata chunk, and all the multimedia data of the multimedia file can be sequentially played without referring back and forth to read any other tables, thereby increasing the speed of reading the multimedia file.

### Fourth Embodiment

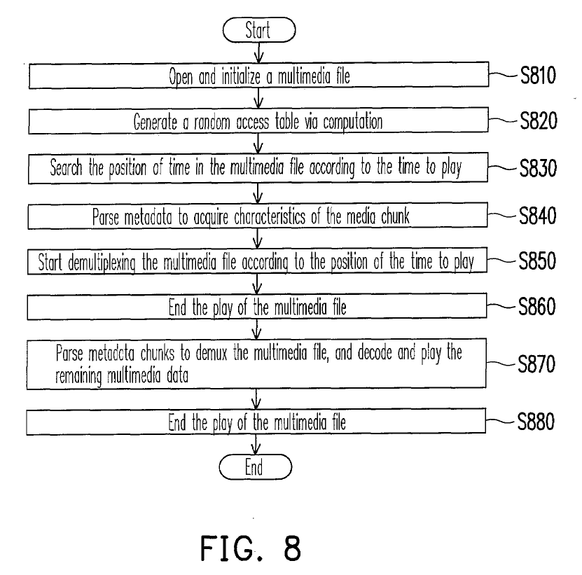

FIG. 8 is a flow chart of a method for skip playing a multimedia file according to the fourth embodiment. Referring to FIG. 8, the method of this embodiment is adapted to skip play the multimedia file as described in the first embodiment. To make it possible to start playing the multimedia file from multimedia data at arbitrary section of the multimedia file, the position of the multimedia data stored in the multimedia file and the length of the multimedia data must be known to allow the multimedia player to correctly search and then play the multimedia data.

As in the previous embodiment, when the multimedia file is played in a skip play manner, first of all, the multimedia file is also opened and initialized (S810). Then, the multimedia file is parsed, and a random access table is generated via computation (S820). The random access table records time and length of each piece of multimedia data, so that when skip playing the multimedia file, the multimedia player needs only refer to the random access table to search out the position of the multimedia data in the multimedia file and then correctly play the desired multimedia data.

The next step is to receive a time to play inputted by a user, and search its position in the multimedia file according to the time to be played (S830). Next, the metadata chunk is parsed to acquire the characteristics of the media chunk (S840). Then, the demultiplexing of the multimedia file is started according to the position of the time to play (S850), and the multimedia data corresponding to the time to play is decoded and played (S860). For example, when a user chooses to start playing a multimedia file from a specific time point, the multimedia player can search out the position of the specific time point in the multimedia file, and then play the multimedia file that the user desires to watch.

Finally, in situation where no other skip instruction is received, as described in the third embodiment, the multimedia player keeps parsing metadata chunks to demux the multimedia file, and decodes and plays the remaining multimedia data (S870), until all the multimedia data is decoded. Then, the play of the multimedia file is ended (S880).

In summary, in skip playing the multimedia file, the multimedia player searches out the position of the multimedia data to be accessed in the multimedia file according to the pre-generated random access table, and directly demultiplexes, decodes and plays the multimedia data from this position. Therefore, whichever time point of the multimedia file the user selects, the multimedia player can always rapidly search out and play a corresponding segment of the multimedia file, making the playing very convenient.

For multimedia files of ISO-MP4 format, the metadata chunks added to the multimedia file when the multimedia file is generated in accordance with the present invention can be recognized and used by the multimedia player. Therefore, the conventional procedures in which the multimedia player needs to first load, process and condense the multimedia data information can be eliminated, thereby reducing the time for preparing the play of the multimedia file.

### Fifth Embodiment

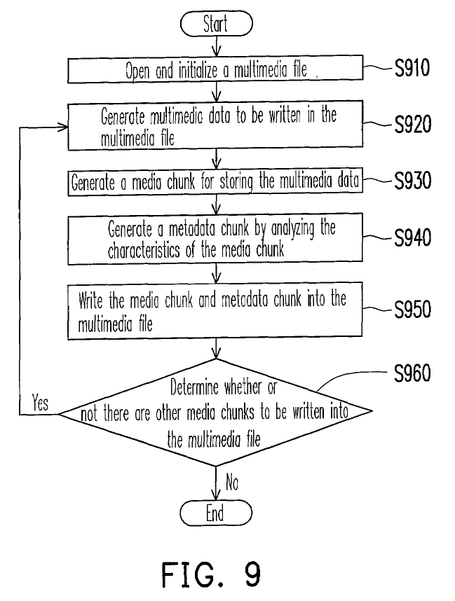

In connection with the new architecture of the multimedia file, the present invention correspondingly provides a method for generating the multimedia file. FIG. 9 is a flow chart of a method for generating a multimedia file according to a second embodiment of the present invention. Referring to FIG. 9, the multimedia file format to which this embodiment is applicable includes, but is not limited to, AVI format and ISO-MP4 format.

In this embodiment, a multimedia file is first opened and initialized (S910). The step of initializing the multimedia file includes generating a header and tracks. In the step of generating the tracks, such as a video track, an audio track, and a sub-picture track, the present invention further includes generating a metadata track for sorting out metadata from other data. The metadata track records format and type of the metadata, and related information thereof, and what type of metadata is included in the multimedia file can be determined via the metadata track. Description of this metadata has been made with respect to the first embodiment, and is therefore not repeated herein.

The next step is to generate multimedia data to be written in the multimedia file (S920). The multimedia data is generated using one of encoding, transcoding, and re-multiplexing (Re-MUX), or any combination thereof.

Next, a media chunk for storing the multimedia data is generated (S930). Next, a metadata chunk including metadata that describes the characteristics of the media chunk and the multimedia data is generated by analyzing the characteristics of the media chunk, for example, length, format, and size of the media chunk (S940). Here, the media chunk and metadata chunk are first generated in a memory and are then written into the multimedia file (S950) with the metadata chunk being arranged in front of the media chunk.

Notably, the type of the multimedia data includes, but not limited to, video data, audio data, and sub-picture data, or the like. Metadata chunks that are generated according to different types of multimedia data record different characteristics of multimedia data. The metadata in front of the video data records data including, for example, video track number, video frame number, video frame type, and time, size, and length of each video frame of the video data. The metadata in front of the audio data records data including, for example, audio track number, audio frame number, and time, size, and length of each audio frame of the audio data. The metadata in front of the sub-picture data records data including, for example, sub-picture track number, sub-picture number, and time, size, and length of each sub-picture of the sub-picture data.

In step S950, once a group of media chunk and metadata chunk are written into the multimedia file, the recording of a group of multimedia data is completed. However, in practice, the step of generation a multimedia file usually includes recording a plurality of pieces of multimedia data, such as video data, audio data, and sub-picture data, in the multimedia file in an interleaving fashion. Therefore, after the recording of each group of media chunk and metadata chunk is completed, it is further determined whether there are other media chunks to be written into the multimedia file (S960). If it is determined that there are other media chunks to be written, then the process flow returns to the step S920 and repeats the steps S920 through S950 to generate other metadata chunks and other media chunks in the multimedia file.

In this embodiment of the present invention, the random access table is not generated. That is, only the header and multimedia data section are present in the multimedia file. Since all information required to generate the random access table can be extracted from metadata chunks in the multimedia data section, it is not needed to compute the random access table immediately. At a later time, the multimedia file can be modified into a AVI or ISO-MP4 file by modifying the header section and generating the random access table section. Multiple multimedia data sections can even be edited and combined into a new AVI or ISO-MP4 file. Random access table for this new AVI or ISO-MP4 file can be created by extracting the metadata chunks from the multimedia data sections in these multiple files. Since the random access table formats for different file formats (AVI or ISO-MP4) are all different, it is not needed to waste computing power and storage space to create the random access table every time. Random access table is only needed when the multimedia file created is intended to be played back correctly on a multimedia player.

In summary, the methods for generating and playing the multimedia file of the present invention has at least the following advantages.

1. The memory used in generating the multimedia file is decreased.

2. The amount of files established in generating the multimedia file is reduced.

3. The procedure for generating the multimedia file is simplified, the time for preparing the play of the multimedia file is reduced, and the memory required to play the multimedia file is reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for generating a multimedia file, comprising:
generating multimedia data to be written into the multimedia file;
generating a media chunk, wherein the media chunk is configured to store the multimedia data;
analyzing the characteristics of the media chunk;
generating a metadata chunk, wherein the metadata chunk comprises metadata that describes the characteristics of the media chunk and the multimedia data;
writing the metadata chunk and the media chunk into the multimedia file, wherein the metadata chunk is arranged in front of the media chunk;
determining whether there are other media chunks to be written into the multimedia file; and
repeating the above steps to generate other metadata chunks and other media chunks if there are other media chunks to be written into the multimedia file.

2. The method for generating a multimedia file as claimed in claim 1, further comprising a step of opening and initializing the multimedia file before generating the multimedia data to be written into the multimedia file, wherein the step of initializing includes generating a header and a data track, and wherein the data track includes a metadata track, an audio data track, a video data track and a sub-picture data track.

3. The method for generating a multimedia file as claimed in claim 1, further comprising scanning the multimedia file and reading the metadata chunks to generate an index table in the multimedia file after all of the media chunks have been written into the multimedia file, wherein the index table records relations among the multimedia data.

4. The method for generating a multimedia file as claimed in claim 3, wherein the step of generating the index table which records relations among the multimedia data in the multimedia file comprises generating a time to sample table, a sample to chunk table, a sample size table, a sync sample table, and a chunk offset table, corresponding to the multimedia data, respectively.

5. The method for generating a multimedia file as claimed in claim 1, further comprising scanning the multimedia file to read the metadata chunk and generating an index table that records relations among the multimedia data once one group of metadata chunk and media chunk are written into the multimedia file, and writing the index table into the multimedia file after all the media chunks are written into the multimedia file.

6. The method for generating a multimedia file as claimed in claim 5, wherein the step of generating the index table that records relations among the multimedia data comprises generating a time to sample table, a sample to chunk table, a sample size table, a sync sample table, and a chunk offset table, corresponding to the multimedia data, respectively.

7. The method for generating a multimedia file as claimed in claim 1, wherein the step of generating the multimedia data comprises one of encoding, transcoding, and re-multiplexing or any combination thereof.

8. The method for generating a multimedia file as claimed in claim 1, wherein the multimedia data comprises video data, audio data, and sub-picture data.

9. The method for generating a multimedia file as claimed in claim 8, wherein the metadata comprises one of video track number, video frame number, video frame type, and time, size and length of each video frame of the video data or any combination thereof.

10. The method for generating a multimedia file as claimed in claim 8, wherein the metadata comprises one of audio track number, audio frame number, audio frame type, and time, size and length of each audio frame of the audio data or any combination thereof.

11. The method for generating a multimedia file as claimed in claim 8, wherein the metadata comprises one of sub-picture track number, sub-picture number, and time, size and length of each sub-picture of the sub-picture data or any combination thereof.

12. The method for generating a multimedia file as claimed in claim 1, wherein a format of the multimedia file comprises one of Audio Video Interleave (AVI) format, and International Organization for Standardization Moving Pictures Experts Group (ISO-MP4) format.

13. A method for playing a multimedia file having a metadata chunk, wherein the multimedia file comprises a plurality of media chunks for recording a plurality of pieces of multimedia data, and a metadata chunk comprises metadata describing the characteristics of the multimedia data arranged in front of each of the media chunks, the method comprising:
opening and initializing the multimedia file;
parsing the metadata chunk to acquire the characteristics of the media chunks;
demultiplexing the multimedia data using the characteristics acquired by parsing the metadata chunk; and
decoding and playing the multimedia data.

14. The method for playing a multimedia file as claimed in claim 13, further comprising a step of parsing the multimedia file, and generating a random access table via computation.

15. The method for playing a multimedia file as claimed in claim 14, further comprising:
searching a position of time to be played in the multimedia file in the random access table according to the time to be played;
starting demultiplexing the multimedia file from the position, and decoding and playing the multimedia data corresponding to the time to be played.

16. The method for playing a multimedia file as claimed in claim 13, wherein after the step of decoding and playing the multimedia data, further comprising:
determining whether or not there is any multimedia data not decoded;
continuing the step of parsing, and then demultiplexing the multimedia file if there is any multimedia data not decoded, and decoding and playing a remaining multimedia data.

17. The method for playing a multimedia file as claimed in claim 13, wherein the multimedia data includes video data, audio data, and sub-picture data.

18. The method for playing a multimedia file as claimed in claim 17, wherein the metadata comprises one of video track number, video frame number, video frame type, and time, size and length of each video frame of the video data or any combination thereof.

19. The method for playing a multimedia file as claimed in claim 17, wherein the metadata comprises one of audio track number, audio frame number, audio frame type, and time, size and length of each audio frame of the audio data or any combination thereof.

20. The method for playing a multimedia file as claimed in claim 17, wherein the metadata comprises one of sub-picture track number, sub-picture number, and time, size and length of each sub-picture of the sub-picture data or any combination thereof.

21. The method for playing a multimedia file as claimed in claim 13, wherein a format of the multimedia file comprises one of Audio Video Interleave (AVI) format, and International Organization for Standardization Moving Pictures Experts Group (ISO-MP4) format.

22. A multimedia player readable recording medium, suitable for recording a multimedia file, the multimedia file comprising:
a header including a description of characteristics of a data track; and
a multimedia data section, configured to store data of the data track, the multimedia data section comprising:
a plurality of media chunks arranged in the multimedia data section and configured to store multimedia data, respectively; and
a plurality of metadata chunks, arranged in the multimedia data section in front of the media chunks, wherein each of the metadata chunks is configured to store metadata that describes the characteristics of the media chunks and the multimedia data, respectively.

23. The multimedia player readable recording medium as claimed in claim 22, wherein the data track comprises an audio data track, a video data track, a sub-picture data track, and a metadata track.

24. The multimedia player readable recording medium as claimed in claim 22, further comprising an index table configured to record relations among the multimedia data.

25. The multimedia player readable recording medium as claimed in claim 24, wherein the index table comprises a time to sample table, a sample to chunk table, a sample size table, a sync sample table, and a chunk offset table corresponding to the multimedia data.

26. The multimedia player readable recording medium as claimed in claim 22, wherein the multimedia data includes video data, audio data, and sub-picture data.

27. The multimedia player readable recording medium as claimed in claim 26, wherein the metadata comprises one of video track number, video frame number, video frame type, and time, size and length of each video frame of the video data or any combination thereof.

28. The multimedia player readable recording medium as claimed in claim 26, wherein the metadata comprises one of audio track number, audio frame number, audio frame type, and time, size and length of each audio frame of the audio data or any combination thereof.

29. The multimedia player readable recording medium as claimed in claim 26, wherein the metadata comprises one of sub-picture track number, sub-picture number, and time, size and length of each sub-picture of the sub-picture data or any combination thereof.
